(19) United States
(12) Patent Application Publication
(10) Pub. No.: US 2009/0063861 A1
(43) Pub. Date: Mar. 5, 2009

(54) Information security transmission system

(76) Inventor: Fong-Chang Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,022

(22) Filed: Dec. 7, 2007

Related U.S. Application Data
(60) Provisional application No. 60/969,766, filed on Sep. 4, 2007.

(51) Int. Cl. H04L 9/32

(52) U.S. Cl. 713/171

(57) ABSTRACT

An information security transmission system is disclosed. The system comprises a first information equipment and a second information equipment, wherein the first information equipment can obtain at least one certification data, connecting to the second information equipment through a network for processing an information transmission, accordingly, a key pair used for encryption/decryption can be obtained through the certificate authority or that can be obtained without the certificate authority selectively, such that the information transmission security channel can be established and the data transmission security can be ensured. The first information equipment and the second information equipment respectively comprises a first dynamic codec and a second dynamic codec for processing a coding/decoding process depending on a dynamic code book, furthermore, an automatic error detecting mechanism and an error correcting mechanism can be associated for ensuring the data transmission security and the data correction especially at one time transmission. The transmission data is under the protection of accessing limit, such as time limit, number of times limit, or equipment limit, such that once the receiver end has received the transmission data, the transmission data can be read under the accessing limit, therefore, if the accessing limit is overtook, then the transmission data would be removed for preventing the data to be lost.

### FIELD OF THE INVENTION

The present invention relates to an information security transmission system, and more particularly to an information security transmission system that is with information transmission security channel for practicing the secured transaction.

### BACKGROUND OF THE INVENTION

Since computers, network system, various wireless portable information equipments are getting more and more popular, a lot of people would like to communicate through these devices and networks. Therefore, in order to the information security can be ensured during data transmission via the network, a third party Certificate authority (CA) has to be demanded. That is, a certification can be obtained for both sides by the CA, and further, a public key and private key used for encryption/decryption can be had, such that the security will be improved during information transmission due to the information has been encrypted and further decrypted. However, the certification data might be lost while the CA has been hacked; furthermore, the key might be cracked by the brute force attack through the key logger, such that the security of the information transmission will be unreliable.

Regarding to the tolerance mechanism of the prior art information transmission system, an automatic repeat request is applied for repeatedly sending data to the receiving terminal till the data is correct while the receiving terminal has received error data, Therefore, the loading of network might be heavier, and further, it might waste time accordingly.

### SUMMARY OF THE INVENTION

It is a primary object of the present invention to provide an information security transmission system, comprising a first information equipment and a second information equipment, both sides of which can directly switch key pair with data encryption/decryption in respect of the information security transmission system can be processed without the certificate authority (CA), such that the data will not be lost even though the certificate authority has been hacked.

It is a secondary object of the present invention to provide an information security transmission system, providing multiple security mechanisms to improve the security during data transmission, including a process of coding/decoding depending on a dynamic code book, and a process of key encryption/decryption.

It is another object of the present invention to provide an information security transmission system, providing a process of coding/decoding depending on a dynamic code book, and further combining with a process of fault-tolerant coding.

It is another object of the present invention to provide an information security transmission system that integrates various different specification information equipments and network for broadening the application fields thereof.

It is another object of the present invention to provide an information security transmission system, comprising an automatic error detecting mechanism and an error correcting mechanism, therefore, a repeat request isn't necessary while the errors are occurred, such that can further improve the efficiency of data transmission through the network.

It is another object of the present invention to provide an information security transmission system, comprising an error counter for preventing the cumulative malice failure certificating that intends to hack the certificate authority.

It is another object of the present invention to provide an information security transmission system, comprising a variable key, such that the information transmission security channel is variable according to the variable key, therefore, the data security can be improved for secured virtual transaction.

It is another object of the present invention to provide an information security transmission system that can determine the accessing limit while the transmitter end is editing the transmission data for preventing the data to be lost.

It is another object of the present invention to provide an information security transmission system, comprising a clearing program provided within the manager program for removing the transmission data, such that the reliability of information transmission between the first information equipment and the second information equipment can be improved.

It is another object of the present invention to provide an information security transmission system, wherein the manager program is provided by a program provider end, therefore, the first information equipment and the second information equipment can have the function of determining the accessing limit without structure alteration.

It is another object of the present invention to provide an information security transmission system, wherein the storage media segments for storing the manage program and the transmission data are isolated for preventing the manage program will not be altered.

It is another object of the present invention to provide an information security transmission system, wherein the storage segments for storing the manage program and the transmission data are isolated for simplifying management of the storage media segments.

It is another object of the present invention to provide an information security transmission system, wherein the transmission data comprises a time content to provide that the transmitter end can determine the accessing limit of the transmission data for having the flexibility of removing or keeping the transmission data.

It is another object of the present invention to provide an information security transmission system, wherein the dynamic code book can be replaced according to the demand for improving the data security.

It is another object of the present invention to provide an information security transmission system, comprising a financial center and a trade object stored within the database for processing a trade transaction between the first information equipment and the second information equipment.

It is another object of the present invention to provide an information security transmission system, comprising a third party certificate authority to associate with the certification process between the first information equipment and the second information equipment to form as a double-certification mechanism.

To achieve the previous mentioned objects, the present invention provides a n information security transmission system, comprising a first information equipment used for obtaining at least one certification data to process information transmission; and a second information equipment connected to the first information equipment through a network, comprising a database, wherein the second information equipment will process the certification login according to the certification data, and further store within the database and have the authorization accordingly; wherein the first information equipment comprises a first key generator for generating a first key pair, including a first public key and a first private key, and the second information equipment comprises a second key generator for generating a second key pair, including a second public key and a second private key, wherein the first public key is transmitted to the second information equipment to process the encryption/decryption, and the second public key is transmitted to the first information equipment to process the encryption/decryption.

To achieve the previous mentioned objects, the present invention further provides an information security transmission system, comprising a first information equipment, comprising a first dynamic codec to process the tolerance coding for a data, which will be transmitted from the first information equipment; and a second information equipment connected to the first information equipment through a network, wherein the second information equipment comprises a second dynamic codec to decode the data, which will be received from the second information equipment; wherein the first dynamic codec comprises a positioned value and a code book, the positioned value points to the code cook, wherein the first dynamic codec will divide a data into a plurality of sub-data segments, the data will be transmitted to the second information equipment, the sub-data segments can be with dynamic data length, wherein the sub-data segments are related with each other depending on the code book, and each sub-data segment is coded by the first dynamic codec in respect to the fault-tolerant coding to be formed as a coding data, which will be transmitted to the second information equipment for data correction.

To achieve the previous mentioned objects, the present invention further provides an information security transmission system, comprising a first information equipment obtaining at least one certification data to process an information transmission; a second information equipment connected to the first information equipment through a network for processing an information transmission with the second information equipment; and a certificate authority connected to the first information equipment and the second information equipment through the network, comprising a certificate authority database, wherein the certificate authority will process certification login according to the certification data, and further the certification data will be stored within the certificate authority database, and an authorization will be obtained for further processing a certification process; wherein the certificate authority will generate a first key pair and second key pair, and transmit the first key pair and second key pair to the first information equipment and second information equipment for processing the encryption/decryption, wherein the first information equipment and second information equipment respectively comprises a first dynamic codec and second dynamic codec, the first dynamic codec generates a positioned value and a code book, the positioned value points to the code book, the first dynamic codec will divide a data into a plurality of sub-data segments, the data will be transmitted to the second information equipment, the sub-data segments can be with, dynamic data length, wherein the sub-data segments are related with each other depending on the code book, and each sub-data segment is coded by the first dynamic codec in respect to the fault-tolerant coding to be formed as a coding data, which will be transmitted to the second information equipment for data correction.

To achieve the previous mentioned objects, the present invention further provides an information security transmission system, comprising a first information equipment comprising at least one first storage media, which is used for storing a manager program and a transmission data, wherein the transmission data comprises an original data and a control content, the transmission data will be transmitted since the original data and the control content have been edited; and a second information equipment comprising at least one second storage media, which is used for storing the manager program and the transmission data received from the second information equipment, wherein the control content of the transmission data will trigger the manager program within the second storage media, and remove the transmission data stored within the second information equipment.

To achieve the previous mentioned objects, the present invention further provides an information security transmission system, comprising a first information equipment comprising at least one first storage media, which is used for storing a transmission data, wherein the transmission data comprises an original data and a control program, the transmission data will be transmitted since the original data and the control program have been edited; and a second information equipment comprising at least one second storage media, which is used for storing the transmission data received from the second information equipment, and processing the control program to remove the transmission data stored within the second information equipment.

### BRIEF DESCRIPTION OF THE DRAWINGS

It will be understood that the figures are not to scale since the individual layers are too thin and the thickness differences of various layers too great to permit depiction to scale.

FIG. 1 is a block diagram of a preferred embodiment of the present invention in respect of the information security transmission system.

FIG. 2A to FIG. 2E are block diagrams of a preferred embodiment of the present invention showing the key switch process.

FIG. 3A is a block diagram of another preferred embodiment of the present invention in respect of the information security transmission system.

FIG. 3B to FIG. 3F are block diagrams of another preferred embodiment of the present invention in respect of the information security transmission system according to the FIG. 3A.

FIG. 4A is a view of a preferred embodiment of the present invention showing the coding/decoding process.

FIG. 4B is a view of another preferred embodiment of the present invention showing the coding/decoding process.

FIG. 4C is a view of a preferred embodiment of the present invention in respect of the code book.

FIG. 4D is a view of another preferred embodiment of the present invention showing the coding/decoding process.

FIG. 5 is a block diagram of another preferred embodiment of the present invention in respect of the information security transmission system.

FIG. 6 is a block diagram of another preferred embodiment of the present invention in respect of the information security transmission system.

FIG. 7 is a block diagram of another preferred embodiment of the present invention in respect of the information security transmission system.

FIG. 8 is a block diagram of another preferred embodiment of the present invention in respect of the information security transmission system.

FIG. 9A is a view of another preferred embodiment of the present invention showing the coding/decoding process.

FIG. 9B is a view of a preferred embodiment of the present invention in respect of the code book.

FIG. 9C is a view of another preferred embodiment of the present invention showing the coding/decoding process.

FIG. 10 is a block diagram of another preferred embodiment of the present invention in respect of the information security transmission system.

FIG. 11 is a block diagram of another preferred embodiment of the present invention in respect of the information security transmission system.

### DETAILED DESCRIPTION OF THE INVENTION

The structural features and the effects to be achieved may further be understood and appreciated by reference to the presently preferred embodiments together with the detailed description.

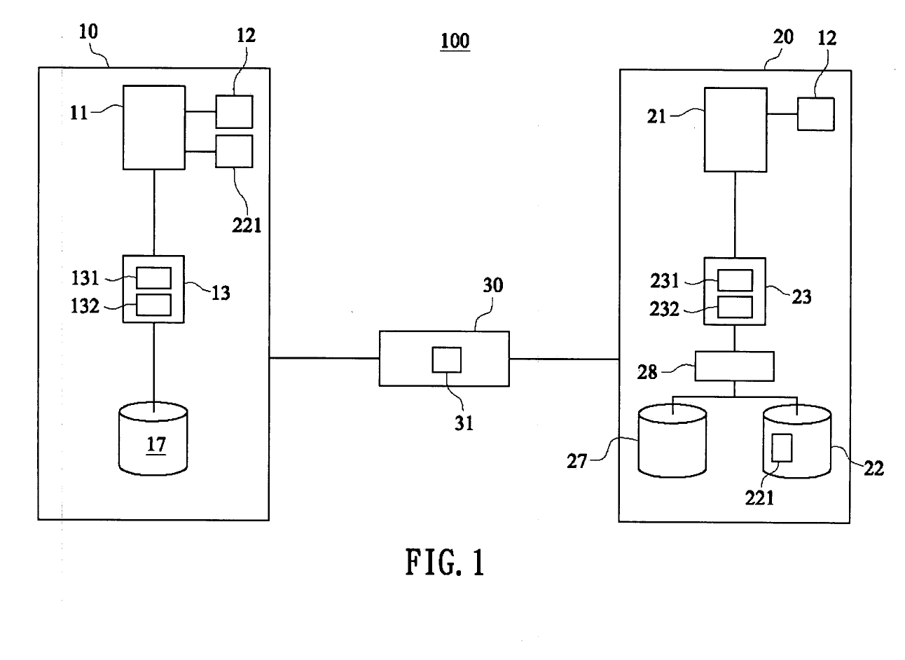

Referring to FIG. 1, a block diagram of a preferred embodiment of the present invention in respect of the information security transmission system is showed. The first information equipment 10 and the second information equipment 20 are connected with each other through a network 30. The first information equipment 10 can obtain at least one certification data 221 and stored within a database 22 of the second information equipment for having the authorization. Therefore, the first information equipment 10 can process an information transmission according to the certification data 221. The first information equipment 10 comprises a first key generator 13 to generate a first key pair, including a first public key 131 and a first private key 132. The second information equipment 20 comprises a second key generator 23 to generate a first key pair, including a first public key 231 and a first private key 232. The first public key 131 is transmitted to the second information equipment 20 for processing encryption/decryption, and the second public key 231 is transmitted to the first information equipment 10 for processing encryption/decryption.

Due to there is without a certificate authority provided between the first information equipment 10 and the second information equipment 20, the keys used for encryption/decryption are respectively generated by the first key generator 13 and the second key generator 23, therefore, the data will not be lost even though the certificate authority has been hacked.

The certification data 221 is presented as a specific data for a user, such as a data stored within an IC card or a data inputted from the first information equipment 10 by a user. The data could be an account, a password, or others. The first information equipment 10 and/or the second information equipment 20 can be a portable mobile communication device, a portable computer, or a desk-top computer. If the first information equipments 10 is a portable mobile communication device, such as a mobile phone, a PDA (Personal Digital Assistant), stocker, and so on, then the IC card should be as a smart card that is with the specifications of SIM (Subscriber Identity Module), USIM (Universal Subscriber Identity Module), R-UIM (Removable User Identity Module), CSIM (CDMA Subscriber Identity Module), or W-SIM (Willcom-Subscriber Identity Module). The network 30 can be a wireless network or a cable network for being a data transmission platform. According to the integration of various different specification information equipments and network, the application fields of the information security transmission system 100 can be broadened. Regarding to one of embodiments of the present invention, a data transfer 31 can be provided within the network 30 for transferring various specifications of the information equipments.

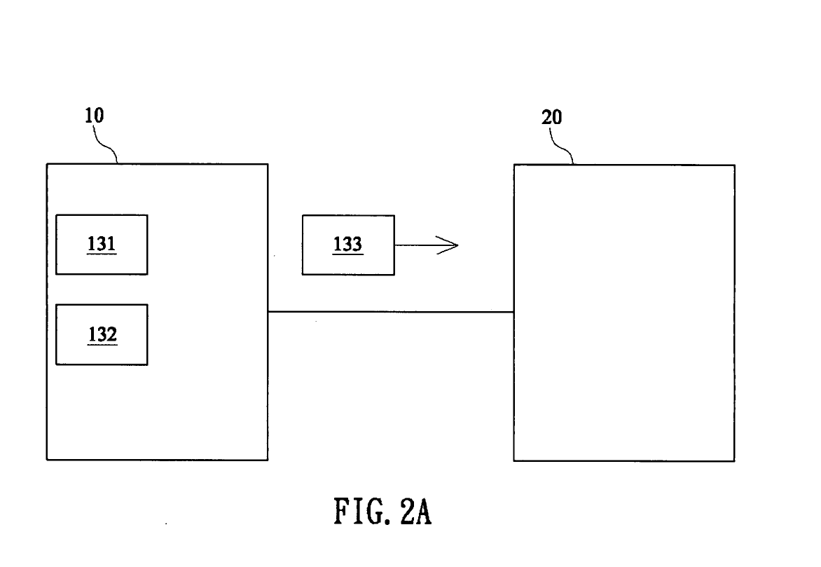

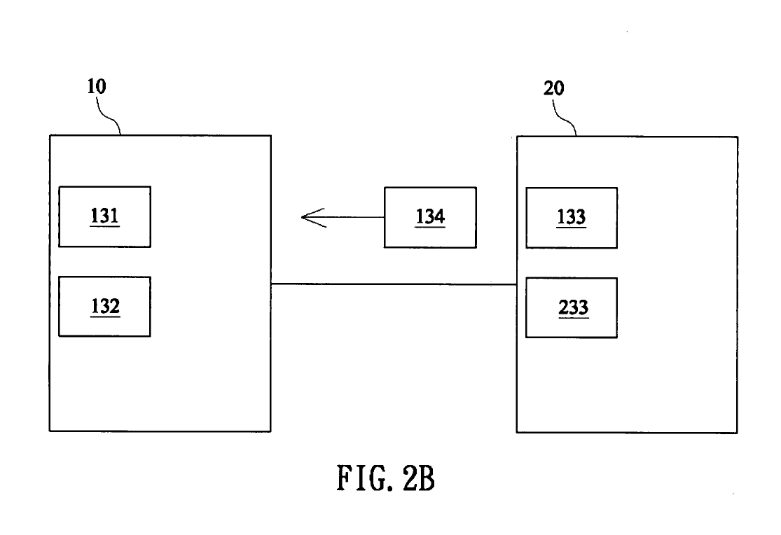

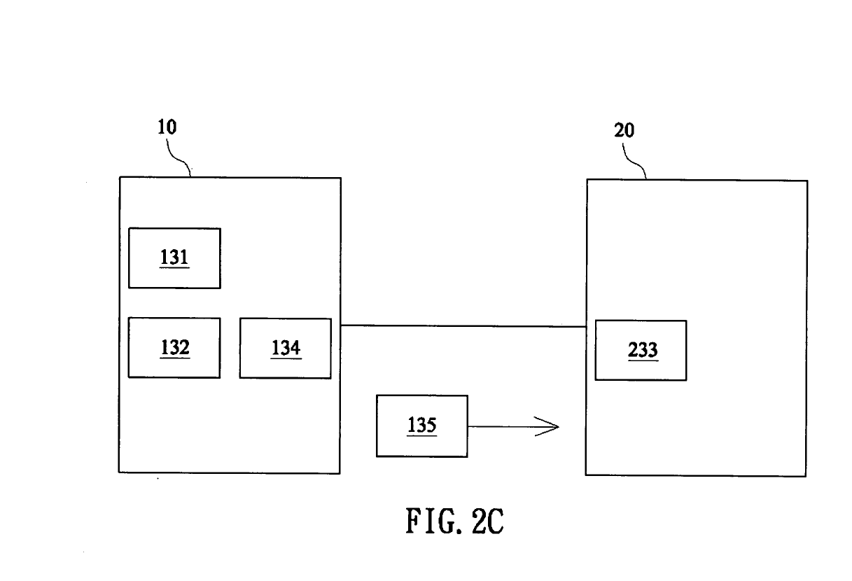

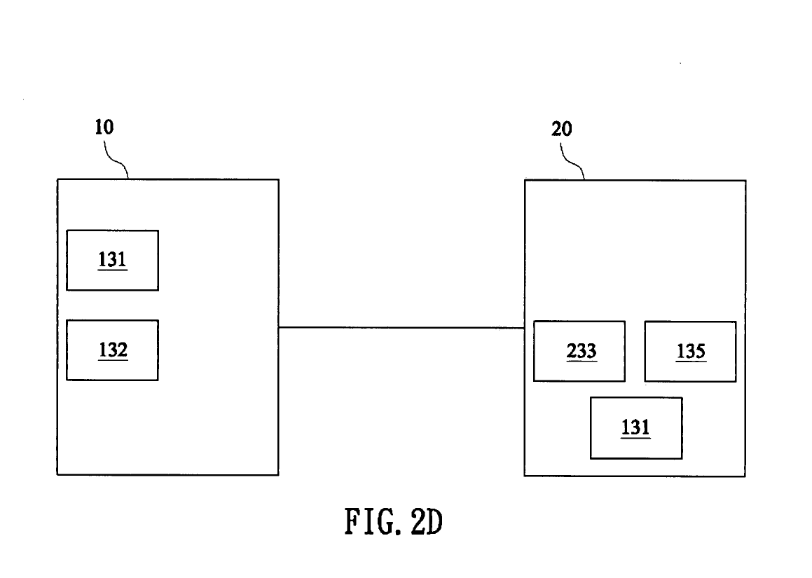

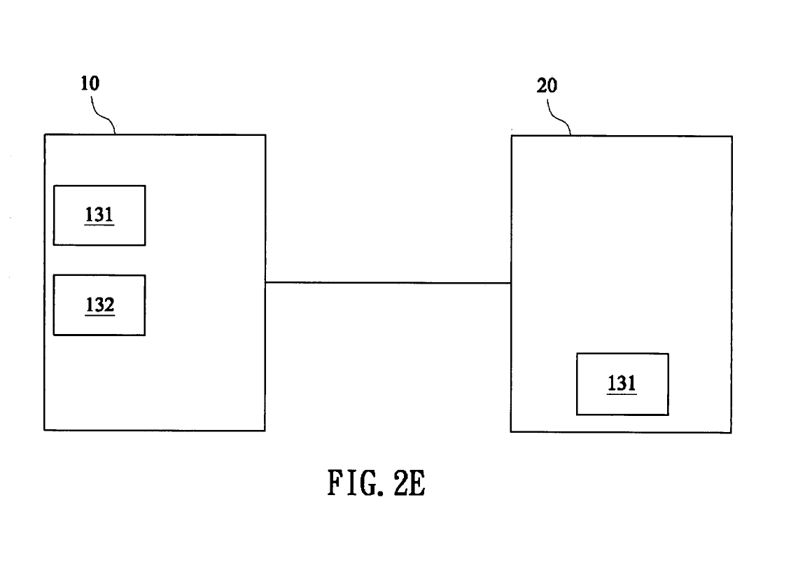

Referring to FIG. 2A to 2E, block diagrams of a preferred embodiment of the present invention showing the key switch process are showed. First, the first key generator 13 generates a first key pair, including the first public key 131 and the first private key 132. The first public key 131 is encrypted to be a first encrypted public key 133 by the first private key 132 and transmitted. Once the second information equipment 20 has received the first encrypted public key 133, the second key generator 23 would generate an encrypting private key 232. The first encrypted public key 133 will be encrypted again by the encrypting private key 232 to be formed as a second encrypted public key 134 and transmitted. And, while the first information equipment 10 has received the second encrypted public key 134, the second encrypted public key 134 could be decrypted by the first private 132 to be formed as a third encrypted public key 135 and transmitted. Finally, while the second information equipment 20 has received the third encrypted public key 135, the third encrypted public key 135 could be decrypted by the encrypting private key 232. Therefore, the second information equipment 20 has the first public key 131 and discards the encrypting private key 232. Similarly, the second public key 231 can be transmitted to the first information equipment 10 also for processing the encryption/decryption as well.

The first public key 131, the first private key 132, the second public key 231, and the second private key 232 are as a variable key that can be changed for the demand according to the agreement of both sides. For example, since the first information equipment 10 would like to change the second public key 231 and the second private key 232, a request will be sent to the second information equipment 20 for requesting the second key generator to generate a new second public key 231 and second private key 232, and further transmitting the new second public key 231 to the first information equipment 10 to process the encryption/decryption. At the same time, the second information equipment 20 will notice the first information equipment 10 to discard the old second public key 231 and second private key 232. Similarly, the second information equipment 20 could send a request to the first information equipment 10 for changing the first public key 131 and the first private key 132 as well. For another example, the first information equipment 10 or the second information equipment 20 can respectively generate a new first public key 131, first private key 132, second public key 231, and second private key 232 at a specific time period. The first information equipment 10 will transmit the new first public key 131 to the second information equipment 20 to process the encryption/decryption, and notice the second information equipment 20 to discard the old first public key 131. The second information equipment 20 will transmit the new second public key 231 to the first information equipment 10 to process the encryption/decryption, and notice the first information equipment 10 to discard the old second public key 231.

The first public key 131, the first private key 132, the second public key 231, and the second private key 232 are variable. Therefore, the information transmission security channel will be altered since the first public key 131, the first private key 132, the second public key 231, and the second private key 232 have been altered every time. Once the transmission data has been cracked by the brute force attack through the key logger, the first information equipment 10 and the second information equipment 20 would discard the cracked first public key 131, first private key 132, second public key 231, and second private key 232, at the same time, the information transmission security channel will be altered also, such that the hackers cannot hack the first information equipment 10 or the second information equipment 20 according to the old first public key 131, first private key 132, second public key 231, and second private key 232.

Regarding to another embodiment of the present invention, the first public key 131, the first private key 132, the second public key 231, and the second private key 232 are a one-time key, which will be discarded after single encryption/decryption process is executed. For example, the first information equipment 10 encrypts the transmission data according to the second public key 231 and transmits to the second information equipment 20, and further, after the transmission data is decrypted by the second private key 232, the first information equipment 10 and the second information equipment 20 will discard the second public key 231 and the second private key 232, at the same time, the second key generator 23 will generate a new second key pair, including the second public key 231 and the second private key 232, and transmit the second public key 231 to the first information equipment 10 to process the next encryption/decryption. Due to the new second key pair is different with the old second key pair, the data security can be ensured accordingly. Similarly, the first public key 131 and the first private key 132 can be as one-time key through similar process also.

The second information equipment 20 further comprises an error counter 28 for recording the number of failure times during the first information equipment 10 is processing the certification process according to the certification data 221, and the account will be closed since the number of failure times is reached a predetermined value. For example, the first information equipment 10 will transmit the certification data 221 to the second information equipment 20 for processing the comparison with the certification data stored within the database 22, if both of which are different, the error counter 28 would record an failure certificating according to the certification data 221. Therefore, while the second information equipment 20 has been certificated maliciously, and the number of failure times is reached a predetermined value, the account will be closed, such that the second information equipment 20 will not accept further malice certifications.

The first information equipment 10 and the second information equipment 20 can process a fault-tolerant coding/decoding process to ensure the data correction during transmission. Regarding to a preferred embodiment of present invention, the fault-tolerant coding process can be selectively as an automatic repeat request or a forward error correction. The fault-tolerant coding process can be selectively as a Cyclic Redundant Check (CRC) code, a Hamming code, a Reed-Solomon (RS) code, a Reed-Muller (RM) code, a Bose-Chauhuri-Hoch quenghem (BCH) code, a Turbo code, a Golay code, a Goppa code, a low-density parity-check code, or a space-time code to achieve the purpose of error correction. The forward error correction is applied for the present invention; therefore, the receiver end is without necessary to send a repeat request to the transmitter end, such that much of the network transmission bandwidth and the expensing time can be saved.

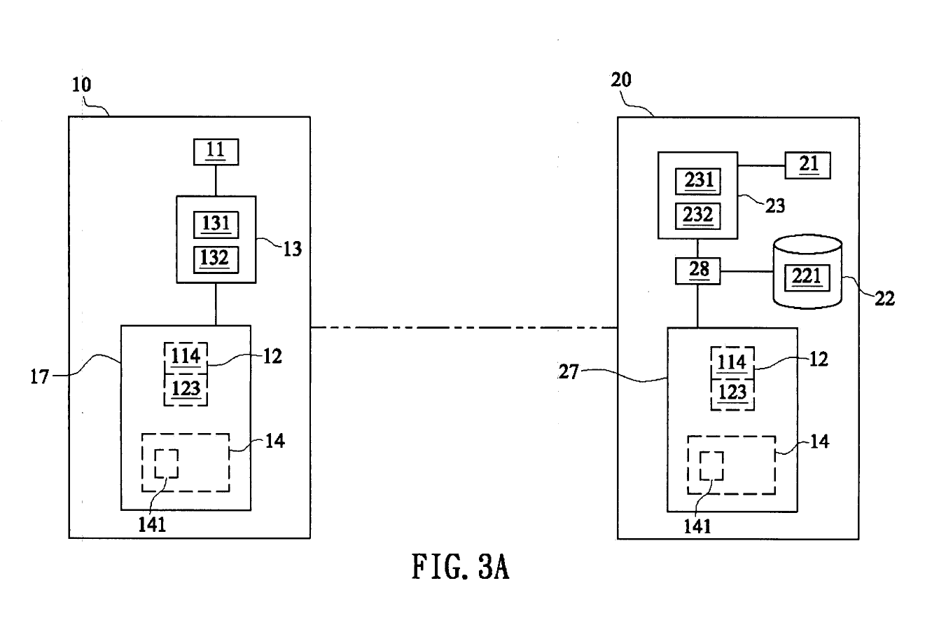

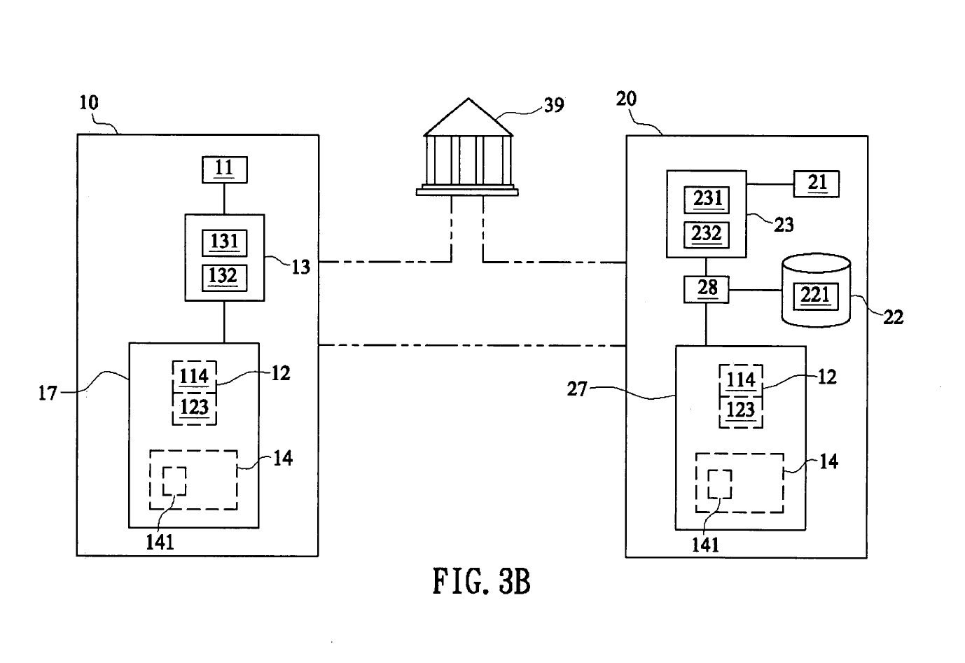

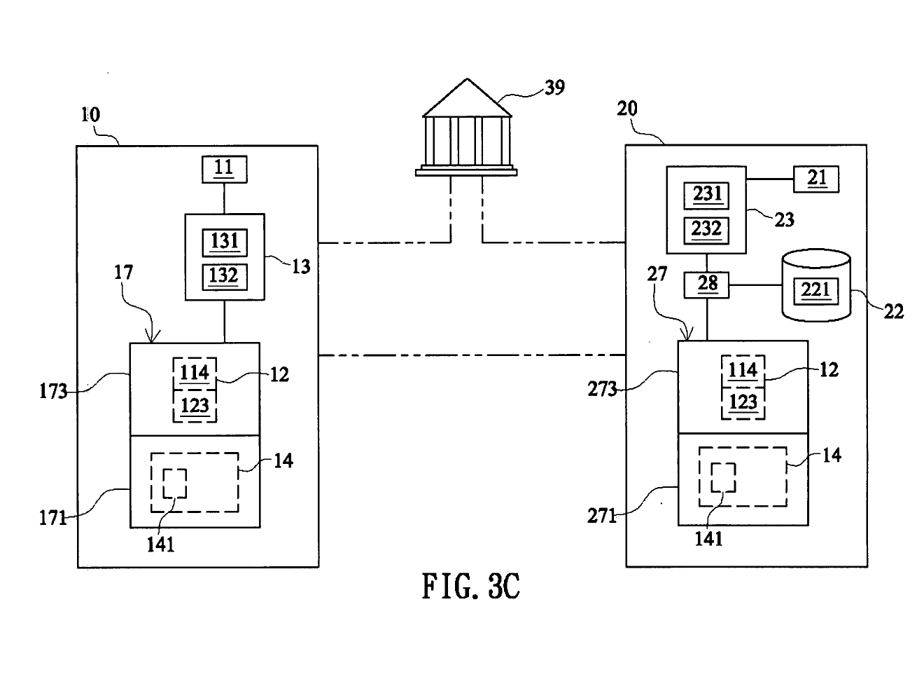

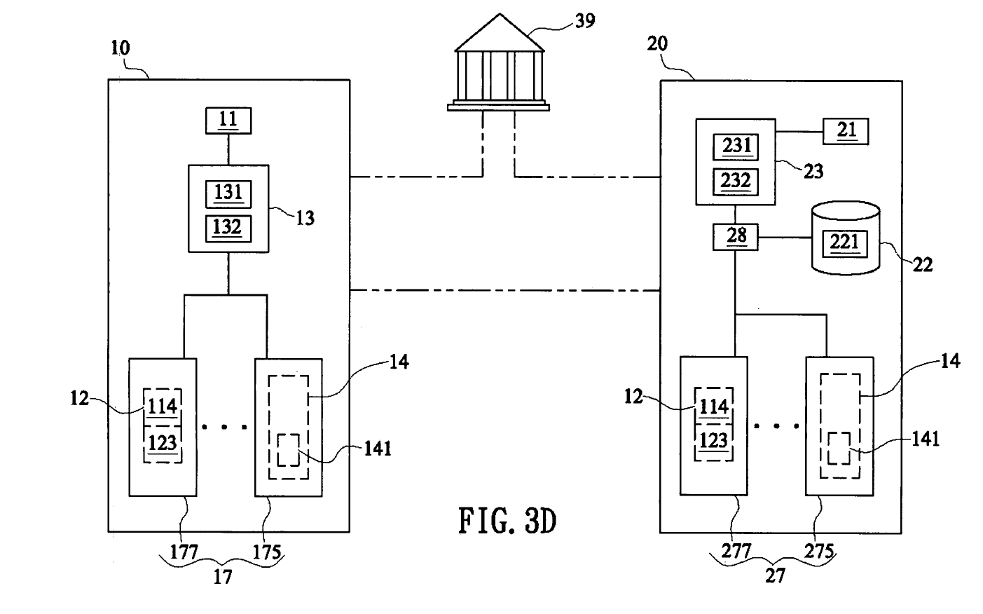

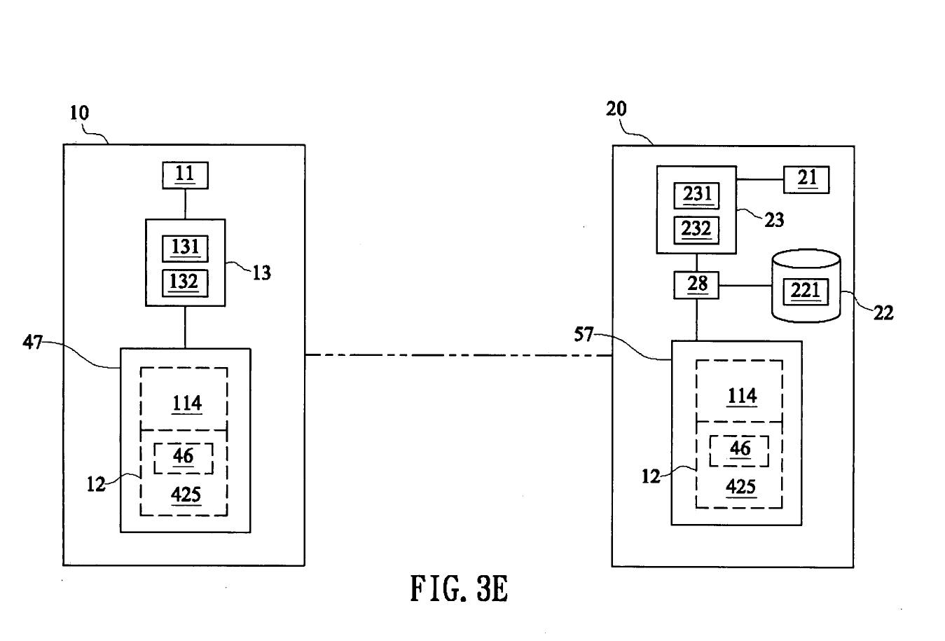

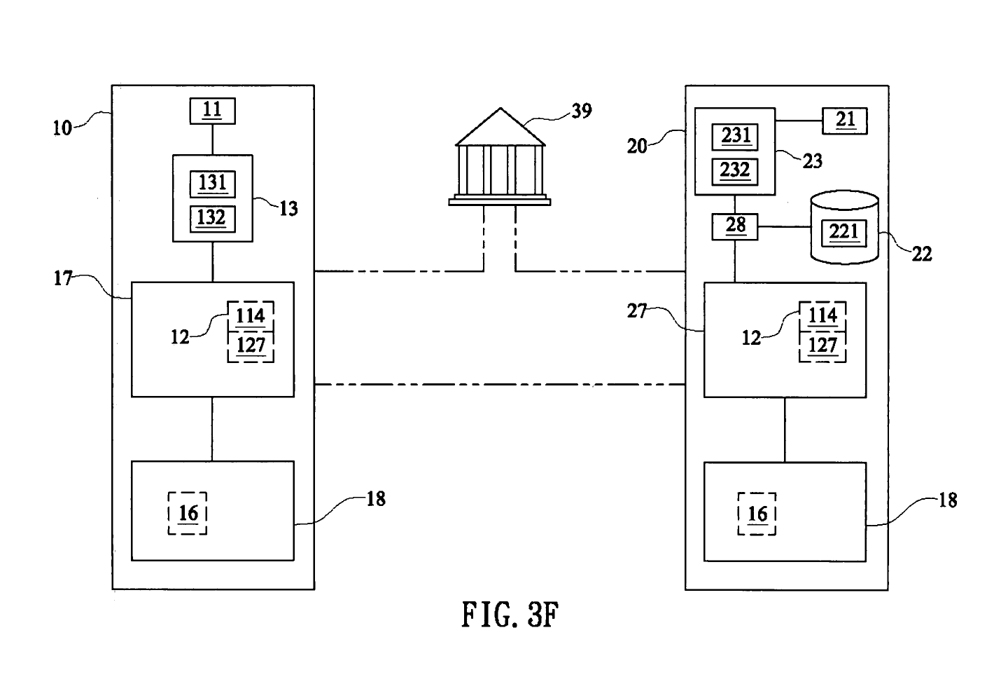

Regarding another preferred embodiment of the present invention, the transmission data between the first information equipment 10 and the second information equipment 20 is with accessing limit, such as time limit, number of times limit, equipment limit. Once the receiver end is as the equipment under the range of the equipment limit, the transmission data would be received and read only around the accessing limit, and further, while the accessing limit is overtook, the transmission data will be removed for preventing data lost, such that the reliability of data transmission between the first information equipment 10 and the second information equipment 20 can be improved. Referring to FIG. 3A, a block diagram of another preferred embodiment of the present invention in respect of the information security transmission system is showed. The first information equipment 10 further comprises at least one first storage media 17 and the second information equipment 20 further comprises at least one second storage media 27. The first storage media 17 and the second storage media 27 are used for storing a manager program 14 and a transmission data 12. While the original data 114 has been edited at the first storage media 17, the control content 123 can be set by the manager program 14 to determine that whether the transmission data 12 is kept or not after the receiver end has read. The accessing time, accessing equipment, number of access times can be set within the control content 123. After the transmission data 12 has been edited and the control content has been set, the transmission data 12 will be encrypted and transmitted according to the keys. After the second information equipment 20 has received the transmission data 12 from the first information equipment 10 and obtained the transmission data according to the process of decryption, the transmission data 12 will be stored within the second storage media 27 for further reading. While the first information equipment 10 has set the control content 123 to be a removing action, the control content 123 will trigger the manager program 14. After the original data 114 has been read and the accessing limit has been overtook, the second information equipment 20 will execute the manager program 14 to remove the transmission data 12 from the second storage media 27.

The original data 114 can be the certification data 221; certainly, the original data 114 can be a words massage, a picture massage, vocal massage, a video massage, or the combination thereof, which can be transmitted between the first information equipment 10 and the second information equipment 20. As the original data 114 is the certification data 221, the certification data 221 will be removed after the first information equipment 10 and the second information equipment 20 have obtained the authorization with each other.

The manager program 14 further comprises a clearing program 141. Once the removing action has been set at the control content and the manager program 141 has been triggered, a random string could be inputted for altering the storage segment that stores the transmission data 12 and remove the transmission data 12 from the second storage media.

The first information equipment 10 can set the control content 123 also. The transmission data 12 read from the second storage media 27 can be kept. Therefore, the important original data 114 can be stored within the second storage media 27, such that the user of the second information equipment 20 can read again the original data 114 thereafter, or that can be used for the comparison of the certification process. The transmission information 12 can be stored within the second storage media 27 or the database 22, such as the certification data 221.

The first storage media 17 and the second storage media 27 can be selectively as a RAM (Random Access Memory), a ROM (Read Only Memory), a SIM (Subscriber Identity Module) card, or a hard disk for storing the manage program 14 and the transmission data 12.

The ROM can be selectively as an EPROM (Erasable Programmable Read-Only Memory), an EEPROM (Electrical Erasable Programmable Read-Only Memory), or a flash memory to be editable for the first storage media 17 and the second storage media 27. The RAM can be selectively as a SRAM (Stable Random Access Memory) or a DRAM (Dynamic Random Access Memory). The hard disk can be selectively as an external hard disk or a micro hard disk.

Once the hard disk is selected as the external hard disk, the first information equipment 10 and the second information equipment 20 respectively would provide a corresponding connecting port for providing the connection with the external hard disk.

Referring to FIG. 3B, the present invention further comprises a program provider end 39 connected with the first information equipment 10 and the second information equipment 20. The manager program 14 provided within the first storage media 17 and the second storage media 27 originally can be provided by the program provider end 39, such that the first information equipment 10 and the second information equipment 20 can have the function of determining the accessing limit without structure alteration.

Referring to FIG. 3C, the first storage media 17 further comprises a first storage area 171 and a first operation area 173. The first storage area 171 and the first operation area 173 are respectively as an individual storage segment divided from a single first storage media 17. The first storage area 171 stores the manager program 14, and the first operation area is used for editing the transmission data 12, therefore, due to these two storage segments has been separated, the manager program 14 will not be altered surely.

The second storage media further comprises a second storage area 271 and a second operation area 273. The second storage area 271 and the second operation area 273 are respectively as an individual storage segment divided from a single second storage media 27. The second storage area 271 and the second operation area 273 are used as well as the previous mentioned.

Referring to FIG. 3D, a plurality of storage medias are provided within the first information equipment 10 and the second information equipment 20, and the manager program 14 is stored within one of the storage medias, the transmission data 12 can be edited at the other storages. Therefore, the manager program 14 and the transmission data 12 are respectively stored within separated storage medias, such that the management of the storage medias can be easier.

The first storage media 17 comprises at least one first fixed storage media 175 and at least one first temporary storage media 177, the second storage media 27 comprises at least one second fixed storage media 275 and at least one second temporary storage media 277. The first fixed storage media 175 and the second fixed storage media 275 can be selectively as a ROM, a SIM card, or a hard disk for storing the manager program 14, such that the manager program 14 will not be lost whether the power supply is supplied or not. The ROM can be selectively as an EPROM, an EEPROM, or a flash memory, and the hard disk can be selectively as an external hard disk or a micro hard disk.

The first temporary storage media 177 and the second temporary storage media 277 can be selectively as a RAM, an EPROM, an EEPROM, a flash memory, a hard disk, and so on, for being edited for the transmission data. The RAM can be selectively as a SRAM or a DRAM, and the hard disk can be selectively as an external hard disk or a micro hard disk. Certainly, if the power supplies of the first information equipment 10 and the second information equipment 20 are supportable enough, the first fixed storage media 175 and the second storage media 275 could be as a RAM.

Referring to FIG. 3E, another preferred embodiment of the present invention in respect of the information security transmission system is showed. The structure of this embodiment is similar with the embodiment shown on the FIG. 3A; however, there is a different between both still. Regarding to disclosure of the FIG. 3A, the first storage media 17 and the second storage media 27 respectively comprises a manager program 14, and the transmission data 12 comprises an original data 114 and a control content 123, wherein the control content 123 is a specific command, which is executable for the manager program 14, and the control content 123 can be set by the manager program 14, and further transmitted since that is integrated with the original data to be formed as a transmission data. While the second information equipment 20 has received the transmission data 12 and read, the control content 123 will trigger the manager program 14 stored within second storage media 27 to execute.

Regarding to the disclosure of FIG. 3E, the first storage media 47 and the second storage media 57 are without the manager program 14, and the transmission data 12 comprises an original data 114 and a control program 425, that is, the functions of control content 123 and the manage program 14 disclosed on the FIG. 3A, can be prosecuted by the control program 425.

As shown on FIG. 3E, the first information equipment 10 comprises at least one first storage media 47 used for storing a transmission data 12, and the second information equipment 20 comprises a second storage media 57 used for storing the transmission data 12 as well. The transmission data 12 comprises an original data 114 and a control program 425, the control program can be transmitted with the original data 114 to execute the specific command. While the original data 114 has been edited at the first storage media 47, the control program 425 can be set at the same time for determining whether the transmission data is kept or not since the receiver has received and read. After the transmission data 12 has been edited and the control program 425 has been set, the transmission data 12 will be encrypted by the key and transmitted.

While the second information equipment 20 has received the data from the first information equipment 10 and decrypted the data by the key to obtain the transmission data 12, the transmission data 112 will be stored within the second storage media 57 for reading. While the first information equipment 10 has set the control program as the removing action, the control program 425 will be executed by the second information equipment 20 since the original data 114 has been read, such that the transmission data 12 will be removed form the second storage media 57.

Referring to FIG. 3F, the manager program 14 can be a module element and provided on the first information equipment 10 and the second information equipment 20. The information equipment 10 comprises a first storage media 17 and a manage module 18, which are connected with each other. Similarly, the second information equipment 20 can be as the same structure also. Due to the manager module 18 is an individual element, the storage structures of first storage media 17 and the second storage media 27 can be simplified.

The transmission data 12 further comprises a time content 127, which is used for providing an accessing time of the transmission data 12 that can be set while the transmission data 12 is edited by the first information equipment 10. While the second information equipment 20 has received the transmission data 12 and read the original data 114, the manager module will be triggered by the time content 127, and then the transmission data 12 will be removed from the second storage media 27 after the accessing time is up, therefore, the accessing time of transmission data 12 can be controlled by the user of the first information equipment 10 flexibly. Certainly, the number of access times or the accessing equipment in respect of the accessing limit can be set by the first information equipment 10 according to the same implementation of previous mentioned.

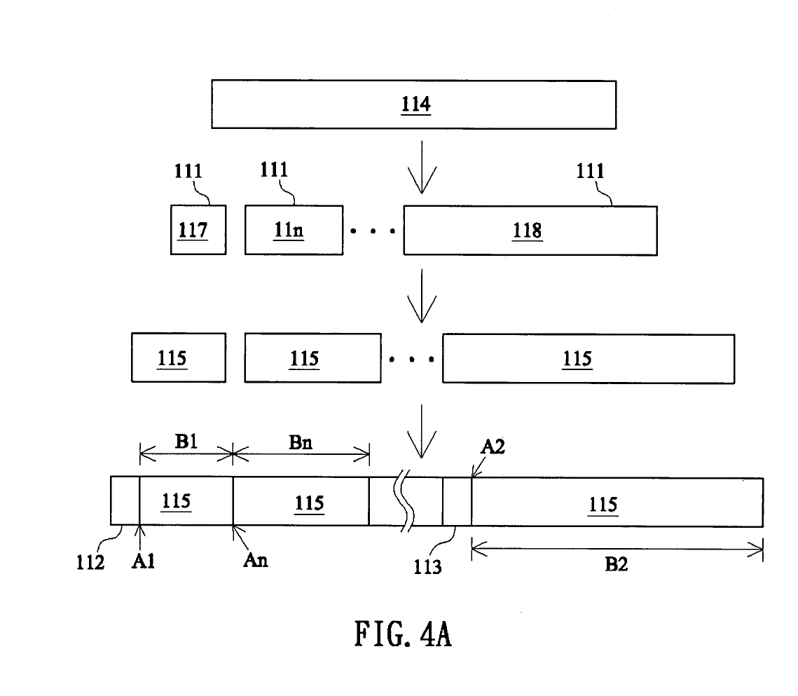

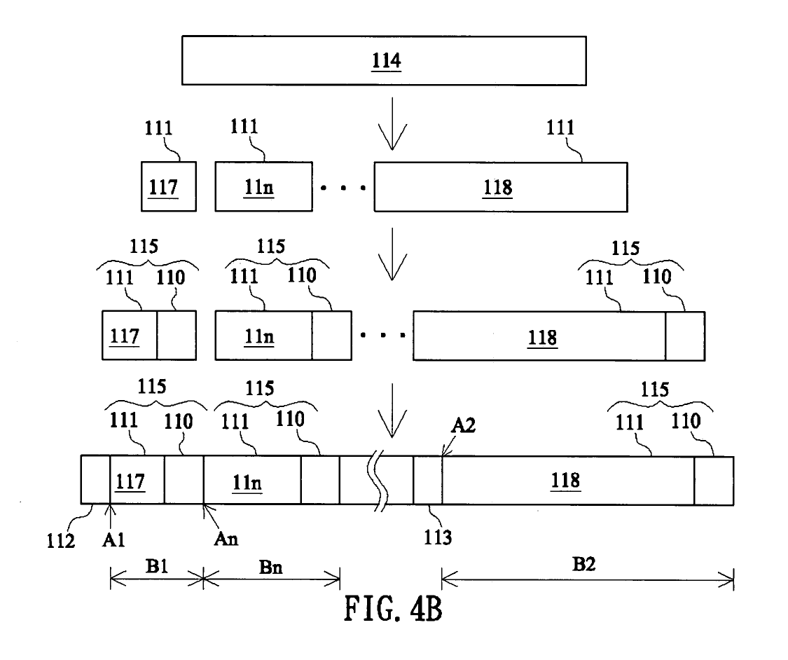

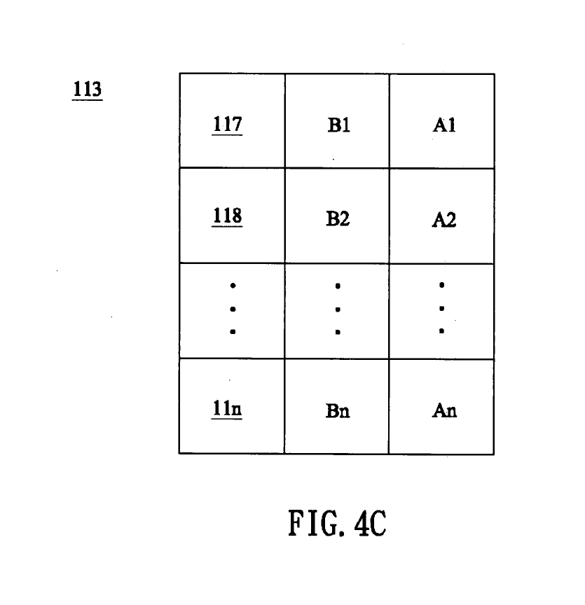

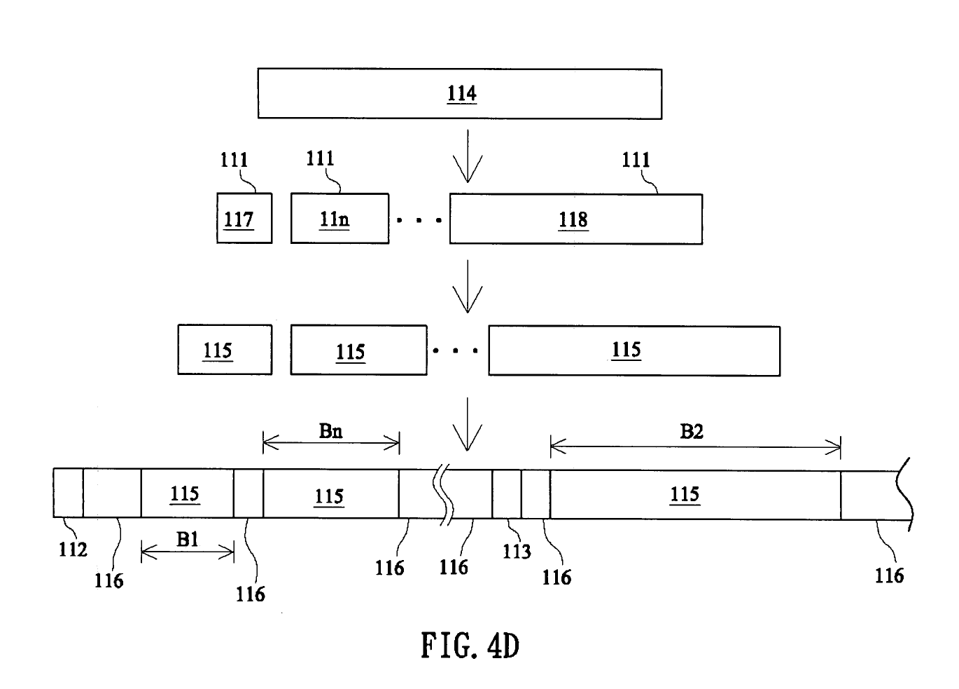

Referring to FIG. 4A to FIG. 4C, the first information equipment 10 is connected to the second information equipment 20 through the network 30. The first information equipment 10 comprises a first dynamic codec 11, which can process a fault-tolerant coding for the transmission data. The second information equipment 20 comprises a second dynamic codec 21, which can decode the received transmission data by the second information equipment 20. The first dynamic codec 11 can generate a positioned value 112 and a code book 113, and the positioned value 112 points to the code book 113. The first dynamic codec 11 can divide the transmission data 12 into a plurality of sub-data segments 111, which are with the dynamic data length. Each sub-data segment 111 is coded by the first dynamic codec 11 for fault-tolerant coding process, such as a Cyclic Redundant Check (CRC) code, a Hamming code, a Reed-Solomon (RS) code, a Reed-Muller (RM) code, a Bose-Chauhuri-Hoch quenghem (BCH) code, a Turbo code, a Golay code, a Goppa code, a low-density parity-check code, or a space-time code, to be formed as a code data 115, as shown on FIG. 4A.

Referring to FIG. 4B, an example for a CRC code, each sub-data segment 111 is coded by the first dynamic codec 11 for processing the fault-tolerant coding, the end of each sub-data segment 111 is added a CRC code 110 to be formed as a code data 115.

Referring to FIG. 4A to FIG. 4C, the code book 113 records the address of each code data 115, the data length and order, such that the code data 115 and the code book can be related, and the data string will be transmitted to the second information equipment 20. While second information equipment 20 has received the data string, the second dynamic codec will be obtained the positioned value 112, and further obtained the code book 113 according to the positioned value 112. According to the address of each code data 115, the data length and order, the each code data can be obtained. Therefore, the second dynamic codec 21 can process the decryption according to each code data 115, and process the error correction to obtain the transmission data 12.

The sub-data segments 111 are with dynamic data length that can be disclosed as following. Assuming that the transmission data 12 is divided by the first dynamic codec 11 into a first sub-data segment 117, a second sub-data segment 118, . . . , a nth sub-data segment 11n, the address of the first sub-data segment 117 is A1, and the data length thereof is B1, wherein the first sub-data segment 117 has been coded by the fault-tolerant coding, the second sub-data segment 118 is A2, and the data length thereof is B2, wherein the second sub-data segment 118 has been coded by the fault-tolerant coding, and further, the nth sub-data segment 11n is An, and the data length thereof is Bn, wherein the nth sub-data segment 11n has been coded by the fault-tolerant coding. The data lengths of above three segments are totally different, and the addresses thereof can be random. The code book 113 records the addresses thereof, the data lengths and order thereof respectively. The positioned value 112 is at the header of the data string, however, which can be at random place also for reducing the possibility of cracking.

The dynamic code book can be changed surely. For example, the first information equipment 10 or the second information equipment 20 can request a changing command to request changing the dynamic code book. At the same time, the first dynamic codec 11 or the second dynamic codec 21 will alter the data length of each sub-data segment 111 for further coding, and address of coded each sub-data segment, data length and order there of will be recorded on the code book 113. Furthermore, the first information equipment 10 or the second information equipment 20 can change the dynamic code book according to a specific time automatically. Therefore, due to the dynamic code book can be changed randomly, the security of the information security transmission system can be improved.

The coding/decoding process according to the dynamic code book and the key encryption/decryption mechanism can be integrated as a multiple encryption/decryption mechanism. The information transmission security channel can be established since the first information equipment 10 and the second information equipment 20 respectively has generated the key pair through the key generators thereof and switched the key. The first dynamic codec 11 will process the fault-tolerant coding process for the transmission data 12, the coded transmission data will be encrypted according to the key, and further, the encrypted coded transmission data will be transmitted. While the second information equipment 20 has received, the encrypted coded transmission data will be decrypted according to the key, and further decoded by the dynamic codec 21 for processing further error detection, after the error detection is finished and the data is correct surely, the transmission data 12 is obtained.

Referring to FIG. 4D, another preferred embodiment of the present invention, each code data 115, the code book 113, and the positioned value 112 can be integrated into an accompanied string 116. The accompanied string 116 is randomly without any meaning generated by the first dynamic codec 11 or the second dynamic codec 21. Certainly, the original data 114 can be coded and decoded according to the fault-tolerant coding/decoding process also.

The accessing limit of the transmission data can be combined with the coding/decoding process according to the dynamic code book and/or the key encryption/decryption mechanism for improving the security of data transmission between the first information equipment 10 and the second information equipment 20.

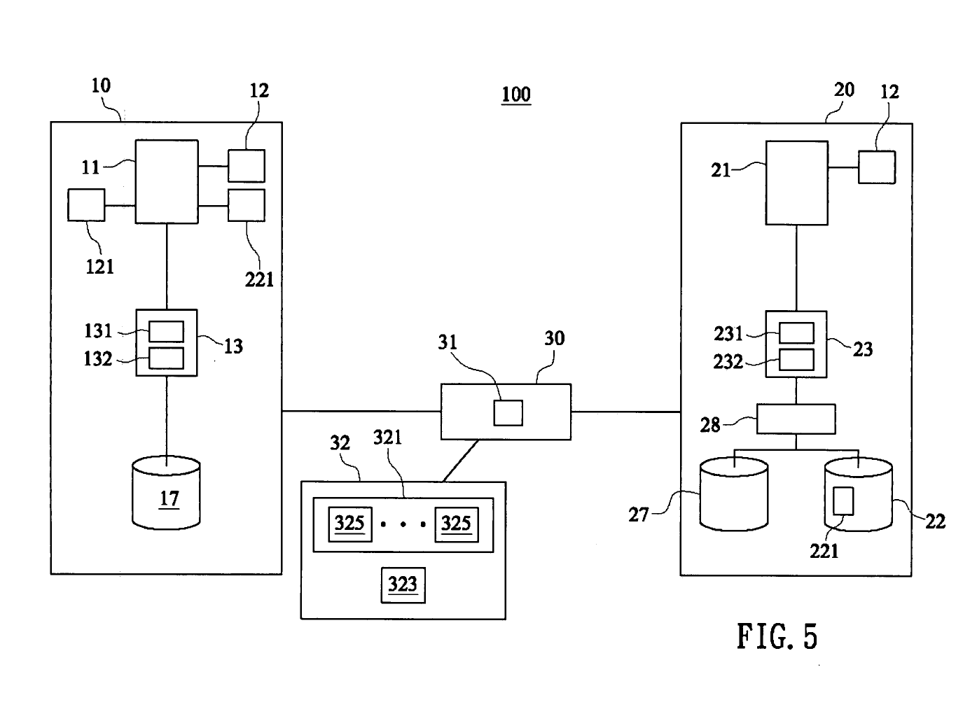

Referring to FIG. 5, the information security transmission system 100 further comprises an information manager end 32 connected to the network 30. The information manager end 32 can be set by at least one conditional content 325. The first information equipment 10 transmits a transmission data 12 to the information manager end 32 through the network 30, and the information manager end 32 will determine whether the transmission data 12 conforms to the conditional content 325 or not, and further, the information manager end 32 will process according to the conditional content 325, accordingly, the information manager end 32 will decide the way of obtaining the transmission data 12 for the second information equipment 20. For example, while the transmission data 12 transmitted from the first information equipment 10 has conformed to the conditional content 325, the information manager end 32 will generates a prompting signal 323 and further transmits the prompting signal 323 to the second information equipment 20 to notice that the information manager end 32 has stored the transmission data 12, wherein the transmission data 12 is stored within a information manager end storage media 321, such that the second information equipment 20 can obtain the transmission data 12 from the information manager end 32 through the network 30. For another example, while the transmission data 12 transmitted from the first information equipment 10 has conformed to the conditional content 325, the information manager end 32 will directly forward to the second information equipment 20. Therefore, due to the information manager end 32 can be set for determining the way of obtaining the transmission data 12 according to the conditional content 325, the data transmission between the first information equipment 10 and the second information equipment 20 can be more efficiency.

Certainly, the data transmission management of the information manager end 32 can be combined with the accessing limit of the transmission data, the coding/decoding process according to the dynamic code book, and/or the key encryption/decryption mechanism for improving the security and efficiency of data transmission between the first information equipment 10 and the second information equipment 20.

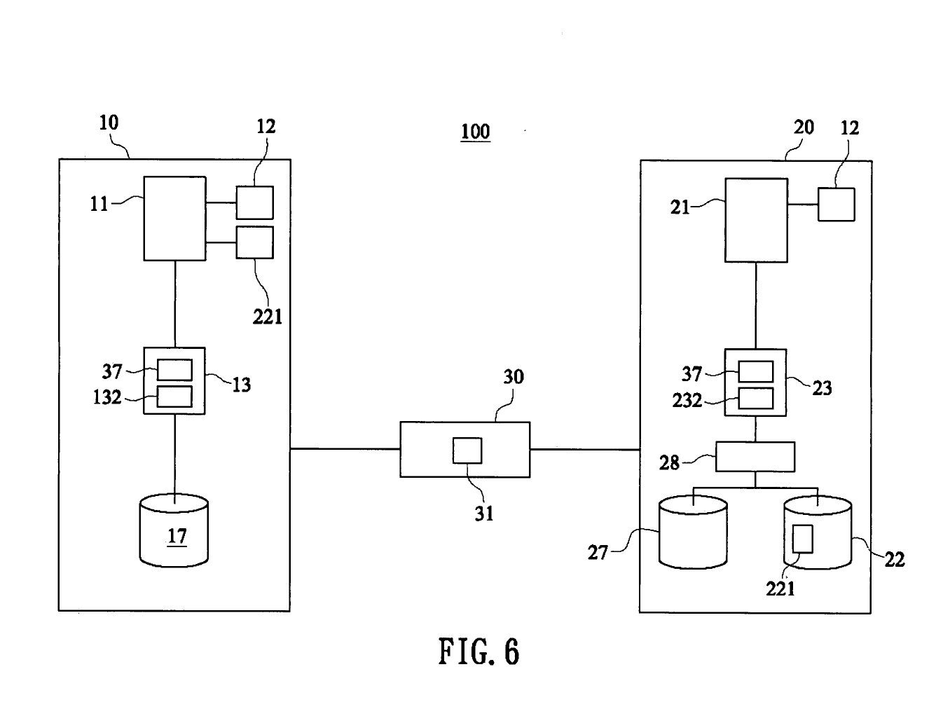

Referring to FIG. 6, regarding to the first information equipment 10 and the second information equipment 20, only one side can generate a public key 37 and transmit the public key 37 to another side through a specific transmission, and another side will obtain the key and process the decryption and encryption. Assuming that the first key generator of the first information equipment 10 generates a key pair, including the public key 37 and a first private key 132, the second information equipment 20 can be without generating the second public key. While the second information equipment 20 has received and further decrypted to obtain the public key 37, the second key generator 23 will generate a second private key 232, which is corresponding to the public key 37 for being a pair, such that the key pair can be used for processing the decryption and encryption in respect of the data transmission between the first information equipment 10 and the second information equipment 20.

The first information equipment 10 can be a client end information equipment or a server end information equipment, and the second information equipment 10 can be a client end information equipment or a server end information equipment also. Once the first information equipment 10 is a client end information equipment and the second information equipment 20 is a server end information equipment, the first information equipment 10 could login to the second information equipment 20 for processing an information transmission or a trade transaction.

Once the first information equipment 10 and the second information equipment 20 are all the client end information equipment or the server end information equipment, the first information equipment 10 and the second information equipment 20 would be presented as a peer-to-peer architecture.

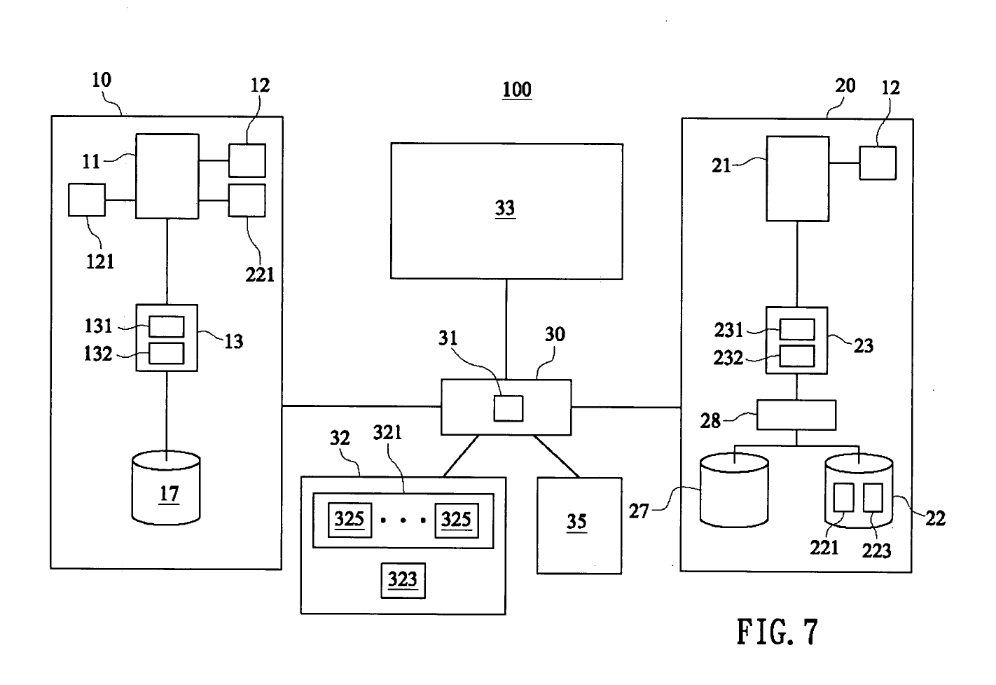

Referring to FIG. 7, while the first information equipment 10 would like to process a trade transaction with the second information equipment 20, the database 22 can further store at least one trading object 223 for the trade transaction. The information security transmission system 100 further comprises a financial center 33 connected to the network 30 for providing a trade transaction for the first information equipment 10 and the second information equipment 20. Meanwhile, the first storage media 17 of the first information equipment 10 will store various information in respect of the trade transaction, the information transmission, the certification process, or the payment process.

The information security transmission system 100 further comprises a third party Certificate Authority (CA) 35 connected to the network 30 for providing the certification process for the first information equipment 10 and the second information equipment 20. The first stage certification process can be processed between the first information equipment 10 and the second information equipment 20, and the second stage certification process can be processed with an association of the third party CA, such that the double-certification mechanism can be presented for ensuring the ID of both sides who would like to process the information transmission or the trade transaction.

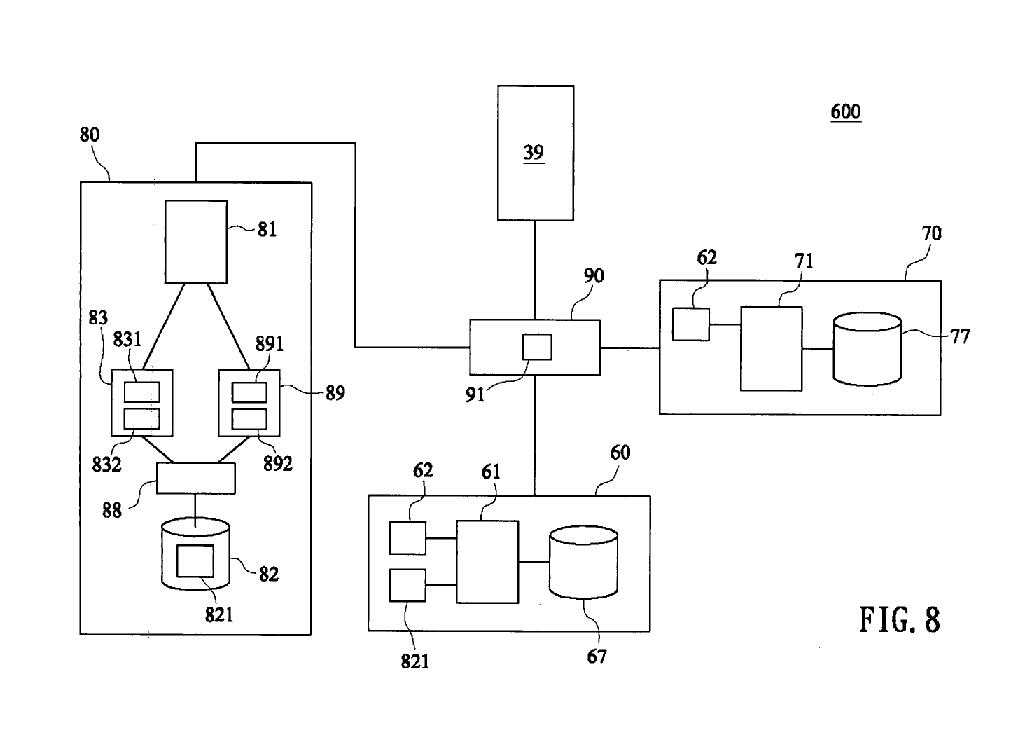

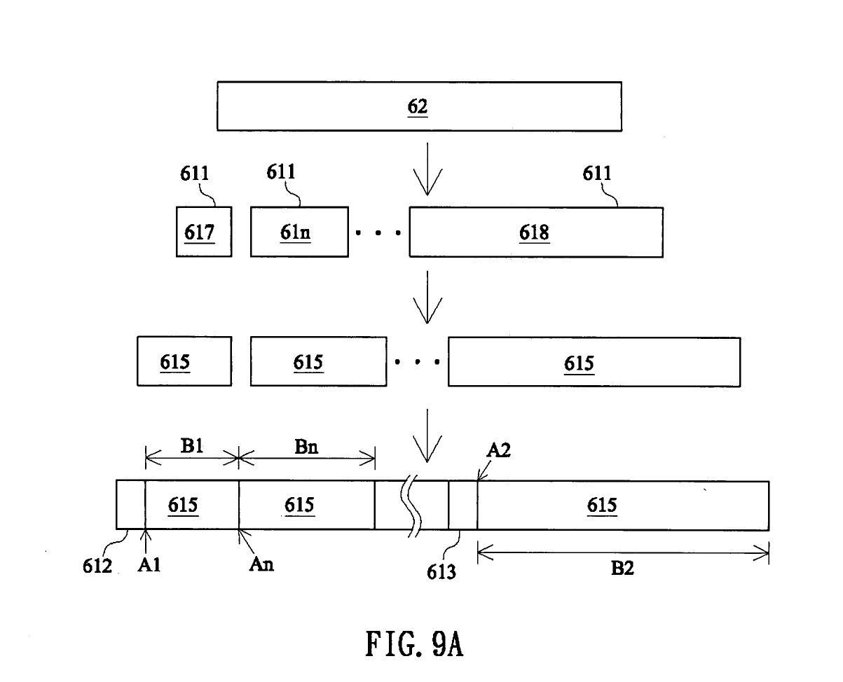

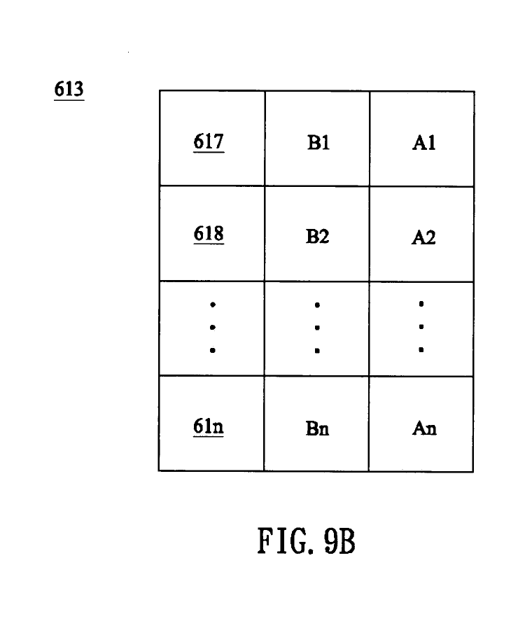

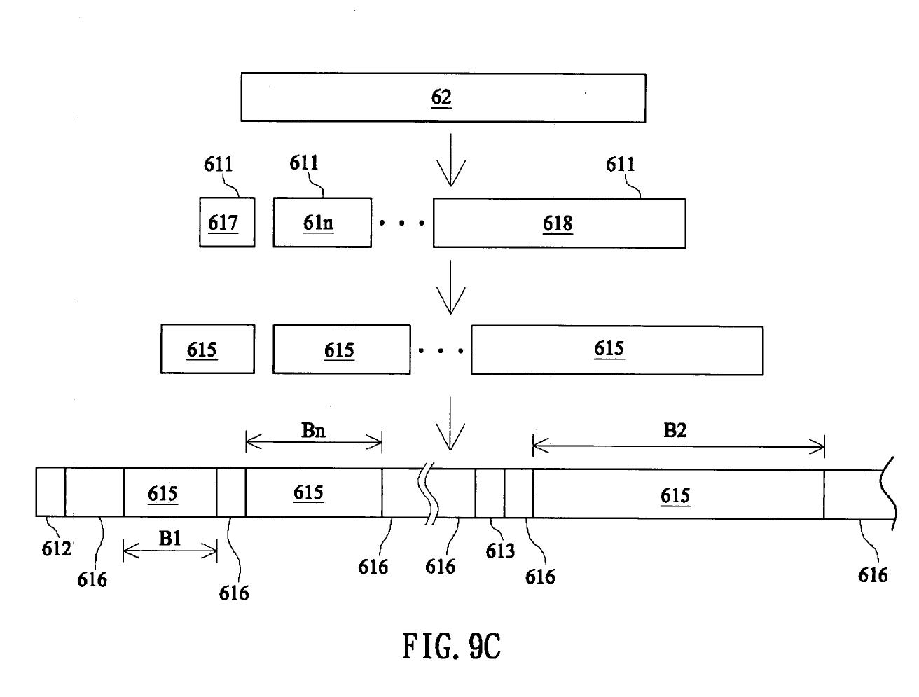

Referring to FIG. 8 to FIG. 9B, a first information equipment 60, a second information equipment 70, and a Certificate Authority (CA) 80 are connected with each other through a network 90. The first information equipment 10 obtains at least one certification data 821 and stores the certification data 821 within a certificate authority database 82 of the CA 80 to have the authorization. Therefore, the first information equipment 60 can obtain the certification data 821 and process a certification process through the CA 80, after the certification process has passed, the CA 80 will notice the second information equipment 70, such that the first information equipment 60 and the second information equipment 70 can begin to process an information transmission accordingly.

The CA accepts the requests from the first information equipment 60 and the second information equipment 70, and generates a first key pair 83 and a second key pair 89, which are transmitted to the first information equipment 60 and the second information equipment 70 for processing the decryption and encryption for the transmitting and receiving data. At the same time, the CA 80 will store the first key pair 83 and the second key pair 89, such that the CA 80 can decrypt and encrypt the transmitting and receiving data by the first key pair 83 between the first information equipment 60, and the CA 80 will store the first key pair 83 and the second key pair 89, and similarly, the CA 80 can decrypt and encrypt the transmitting and receiving data by the second key pair 89 between the second information equipment 70. The first key pair 83 comprises a first public key 831 and a first private key 832, and the second key pair 89 comprises a second public key 891 and a second private key 892. The CA 80 will transmit the second public key 891 and the first private key 832 to the first information equipment 60, and transmit the first public key 831 and the second private key 892 to the second information equipment 70.

The first information equipment 60 comprises a first dynamic codec 61, the second information equipment 70 comprises a second dynamic codec 71, and the CA 80 comprises a CA dynamic codec 81 for processing a coding/decoding process according to a dynamic code book and achieving the purpose of processing the fault-tolerant coding process. Referring to FIG. 9A to FIG. 9B, the first dynamic codec 61 generates a positioned value 612 and a code book 613, and the positioned value 612 points to the code book 613. The first dynamic codec 61 divides a transmission data 62 into a plurality of sub-data segments 611, which are with dynamic data length. Each sub-data segment 611 is coded by the first dynamic codec 61 for fault-tolerant coding process, such as a Cyclic Redundant Check (CRC) code, a Hamming code, a Reed-Solomon (RS) code, a Reed-Muller (RM) code, a Bose-Chauhuri-Hoch quenghem (BCH) code, a Turbo code, a Golay code, a Goppa code, a low-density parity-check code, or a space-time code, to be formed as a code data 615. The code book 613 records the address of each code data 615, the data length and order, such that the code data 615 and the code book can be related, and the data string will be transmitted to the second information equipment 70, as shown on FIG. 9A to FIG. 9B. While second information equipment 70 has received the data string, the second dynamic codec 71 will be obtained the positioned value 612, and further obtained the code book 613 according to the positioned value 612. According to the address of each code data 615, the data length and order, the each code data 615 can be obtained. Therefore, the second dynamic codec 71 can process the decryption according to each code data 615, and process the error correction to obtain the transmission data 62.

The fault-tolerant coding process can be selectively as an automatic repeat request or a forward error correction to achieve the purpose of error correction. The forward error correction is applied for the present invention; therefore, the receiver end is without necessary to send a repeat request to the transmitter end, such that much of the network transmission bandwidth and the expensing time can be saved. The positioned value 612 is at the header of the data string, however, which can be at random place also for reducing the possibility of cracking.

Due to the coding/decoding process according to the dynamic code book and the key encryption/decryption mechanism can be integrated as a multiple encryption/decryption mechanism, the information transmission security channel can be established between the first information equipment 60 and the second information equipment 70 since the first information equipment 60 and the second information equipment 70 respectively has requested to the CA 80 to obtain the key pair. The first dynamic codec 61 will process the fault-tolerant coding process for the transmission data 62, the coded transmission data will be encrypted according to the key, and further, the encrypted coded transmission data will be transmitted. While the second information equipment 70 has received, the encrypted coded transmission data will be decrypted according to the key, and further decoded by the dynamic codec 71 for processing further error detection, after the error detection is finished and the data is correct surely, the transmission data 62 is obtained.

Referring to FIG. 9C, another preferred embodiment of the present invention, each code data 615, the code book 613, and the positioned value 612 can be integrated into an accompanied string 616. The accompanied string 616 is randomly without any meaning generated by the first dynamic codec 61 or the second dynamic codec 71.

The first key pair 83 and the second key pair 89 are as a variable key that can be changed for the demand according to the agreement of both sides. For example, since the second information equipment 60 would like to change the key, a request will be sent to the CA 80 for requesting to generate a new first key pair 83 or second key pair 89, and further transmitting to the first information equipment 60 and/or the second information equipment 70 to process the encryption/decryption. Similarly, the first information equipment 60 could send a request to the CA 80 for changing the key pairs as well. For another example, the CA 80 can generate new key pairs at a specific time period, and transmit to the first information equipment 60 and/or the second information equipment 70 to process the encryption/decryption, and notice the first information equipment 60 and/or the second information equipment 20 to discard the old key pairs.

The first public key 831, the first private key 832, the second public key 891, and the second private key 892 are variable. Therefore, the information transmission security channel will be altered since the first public key 831, the first private key 832, the second public key 891, and the second private key 892 have been altered every time. Once the transmission data has been cracked by the brute force attack through the key logger, the first information equipment 60 and the second information equipment 70 would discard the cracked first public key 831, first private key 832, second public key 891, and second private key 892, at the same time, the information transmission security channel will be altered also, such that the hackers cannot hack the first information equipment 60, the second information equipment 70, or the CA 80 according to the old first public key 831, first private key 832, second public key 891, and second private key 892.

Regarding to another embodiment of the present invention, the first public key 831, the first private key 832, the second public key 891, and the second private key 892 are a one-time key, which will be discarded after single encryption/decryption process is executed. For example, the first information equipment 60 encrypts the transmission data according to the second public key 831 and transmits to the second information equipment 70, and further, after the transmission data is decrypted by the second private key 832, the first information equipment 60 and the second information equipment 70 will discard the second public key 831 and the second private key 832, at the same time, the second information equipment 70 will request to the CA 80 to generate a new second key pair, including the second public key 831 and the second private key 832, and transmit the second public key 831 to the first information equipment 60 to process the next encryption/decryption. Due to the new second key pair is different with the old second key pair, the data security can be ensured accordingly. Similarly, the first public key 831 and the first private key 832 can be as one-time key through similar process also.

While the CA has generated a new first public key 831, first private key 832, second public key 891, and second private key 892, the CA 80 will discard the old first public key 831, first private key 832, second public key 891, and second private key 892, and store the new first public key 831, first private key 832, second public key 891, and second private key 892.

The information security transmission system 600 further comprises an error counter 88 for recording the number of failure times during the first information equipment 60 is processing the certification process according to the certification data 221, and the account will be closed since the number of failure times is reached a predetermined value. For example, the first information equipment 60 will transmit the certification data 821 to the CA 80 for processing the comparison with the certification data stored within the CA database 82, if both of which are different, the error counter 88 would record an failure certificating according to the certification data 821. Therefore, while the CA 80 has been certificated maliciously, and the number of failure times is reached a predetermined value, the account will be closed, such that the CA 80 will not accept further malice certifications.

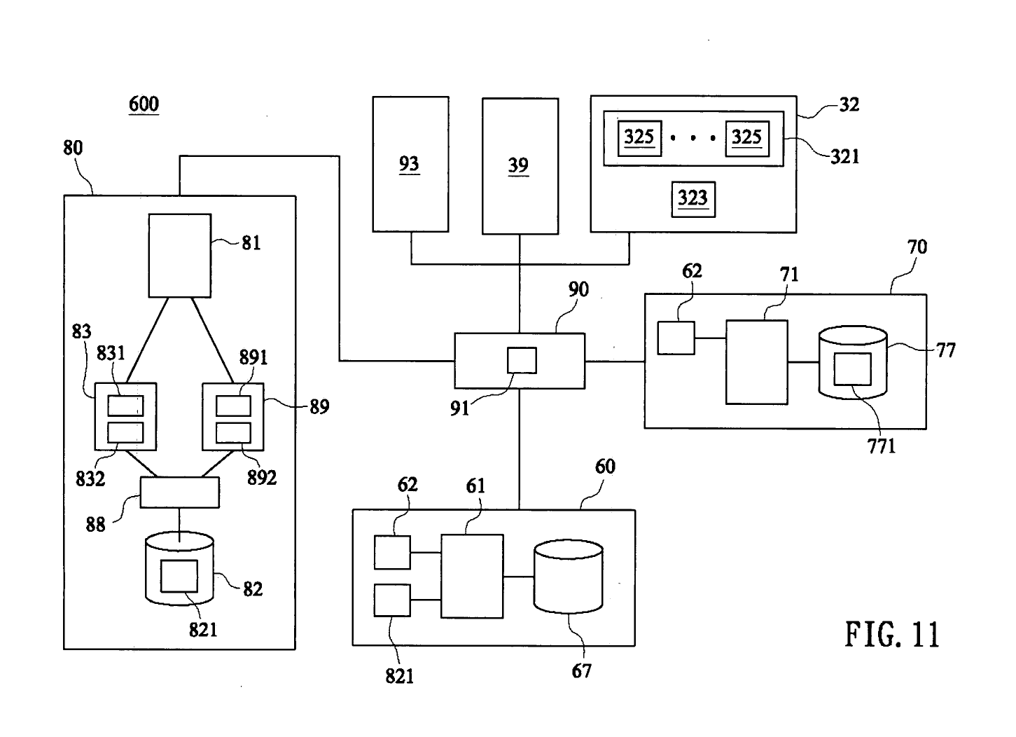

The first information equipment 60 can be a client end information equipment or a server end information equipment, and the second information equipment 70 can be a client end information equipment or a server end information equipment also. Once the first information equipment 60 is a client end information equipment and the second information equipment 70 is a server end information equipment, the first information equipment 60 could login to the second information equipment 70 for processing an information transmission or a trade transaction since the first information equipment 60 has processed the certification process at the CA 80. Referring to FIG. 11, while the first information equipment 60 would like to process a trade transaction with the second information equipment 70, the second information equipment 70 further comprises a second storage media 77 for storing at least trading object.

Once the first information equipment 60 and the second information equipment 70 are all the client end information equipment or the server end information equipment, the first information equipment 60 and the second information equipment 70 would be presented as a peer-to-peer architecture.

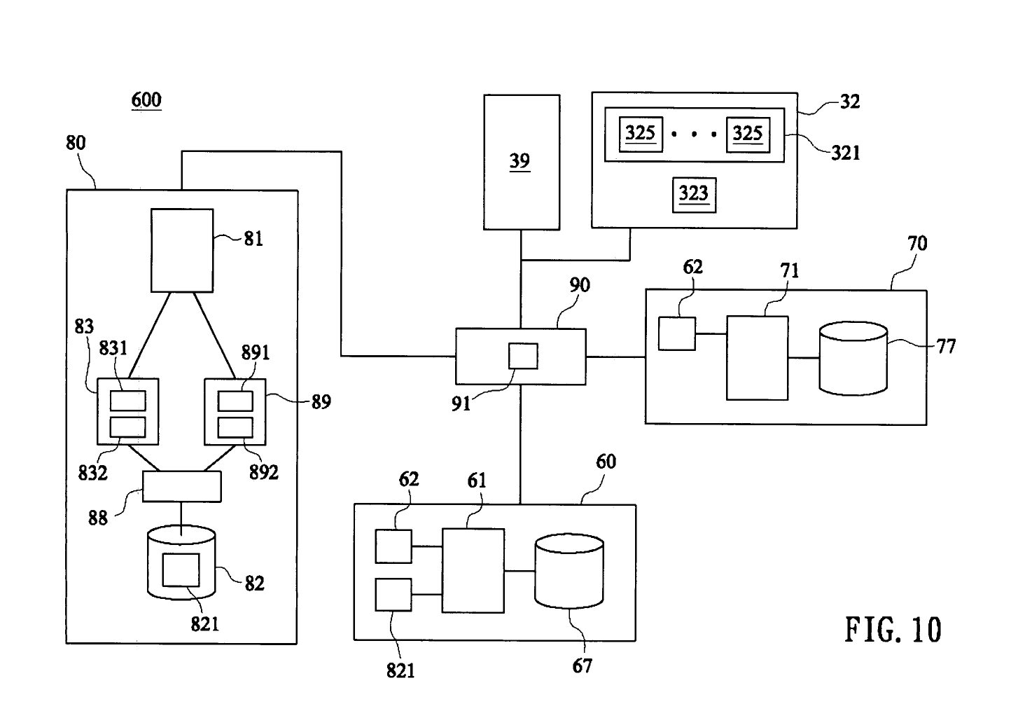

Referring to FIG. 10, the information security transmission system 600 further comprises an information manager end 32 connected to the network 90. The information manager end 32 can be set by at least one conditional content 325. The first information equipment 60 transmits a transmission data 62 to the information manager end 32 through the network 90, and the information manager end 32 will determine whether the transmission data 62 conforms to the conditional content 325 or not, and further, the information manager end 32 will process according to the conditional content 325, accordingly, the information manager end 32 will decide the way of obtaining the transmission data 12 for the second information equipment 70. Therefore, due to the information manager end 32 can be set for determining the way of obtaining the transmission data 62 according to the conditional content 325, the data transmission between the first information equipment 60 and the second information equipment 70 can be more efficiency.

Referring to FIG. 11, the information security transmission system 600 further comprises a financial center 93 connected to the network 90 for providing a trade transaction for the first information equipment 60 and the second information equipment 70. Meanwhile, a first storage media 67 of the first information equipment 60 will store various information in respect of the trade transaction, the information transmission, the certification process, or the payment process.

Regarding to another preferred embodiment of the present invention, the transmission data between the first information equipment 60 and the second information equipment 70 is with the accessing limit, once the receiver end is as the equipment under the range of the equipment limit, the transmission data would be received and read only around the accessing limit, and further, while the accessing limit is overtook, the transmission data will be removed for preventing data lost, such that the reliability of data transmission between the first information equipment 60 and the second information equipment 70 can be improved.

The data transmission management of the information manager end 32, the accessing limit of the transmission data, the coding/decoding process according to the dynamic code book, and/or the key encryption/decryption mechanism can be integrated with each other surely for improving the security and efficiency of data transmission between the first information equipment 10 and the second information equipment 20.

Finally, the first information equipment 60 and/or the second information equipment 70 can be a portable mobile communication device, a portable computer, or a desk-top computer. If the first information equipments 10 is a portable mobile communication device, such as a mobile phone, a PDA (Personal Digital Assistant), stocker, and so on, then the IC card should be as a smart card that is with the specifications of SIM (Subscriber Identity Module), USIM (Universal Subscriber Identity Module), R-UIM (Removable User Identity Module), CSIM (CDMA Subscriber Identity Module), or W-SIM (Willcom-Subscriber Identity Module). The network 90 can be a wireless network or a cable network for being a data transmission platform. According to the integration of various different specification information equipments and network, the application fields of the information security transmission system 600 can be broadened. Regarding to one of embodiments of the present invention, a data transfer 91 can be provided within the network 90 for transferring various specifications of the information equipments.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

I claim:

1. An information security transmission system, comprising:
a first information equipment used for obtaining at least one certification data to process information transmission; and
a second information equipment connected to said first information equipment through a network, comprising a database, wherein said second information equipment will process the certification login according to said certification data, and further store within said database and have the authorization accordingly;
wherein said first information equipment comprises a first key generator for generating a first key pair, including a first public key and a first private key, and said second information equipment comprises a second key generator for generating a second key pair, including a second public key and a second private key, wherein said first public key is transmitted to said second information equipment to process the encryption/decryption, and said second public key is transmitted to said first information equipment to process the encryption/decryption.

2. The information security transmission system of claim 1, wherein said first information equipment and said second information equipment can respectively send a request actively for switching said key pairs.

3. The information security transmission system of claim 1, wherein said first information equipment and said second information equipment are respectively selected to be a client end information equipment or a server end information equipment.

4. The information security transmission system of claim 1, wherein said first information equipment further comprises a first dynamic codec, and said second information equipment further comprises a second dynamic codec, wherein said first dynamic codec comprises a positioned value and a code book, said positioned value points to said code cook, wherein said first dynamic codec will divide a data into a plurality of sub-data segments, said data will be transmitted to said second information equipment, said sub-data segments can be with dynamic data length, wherein said sub-data segments are related with each other depending on said code book, and each sub-data segment is coded by said first dynamic codec in respect to the fault-tolerant coding to be formed as a coding data, which will be transmitted to said second information equipment for data correction.

5. The information security transmission system of claim 1, wherein said first information equipment further comprises a first storage media, and said second information equipment further comprises a second storage media, wherein said first storage media is used for storing a manager program and a transmission data, said transmission data comprises a original data and a control content, said transmission data will be transmitted since said original data and said control content have been edited, wherein said second storage media stores the same manager program as well, and will store the transmission data received from said second information equipment, wherein said control content of said transmission data will trigger said manager program within said second storage media, and remove said transmission data stored within said second information equipment.

6. The information security transmission system of claim 5, wherein said first storage media comprises a first storage area and a first operation area, said first storage area is used for storing said manager program, and said first operation area is used for storing said transmission data, furthermore, said second storage media comprises a second storage area and a second operation area, said second storage area is used for storing said manager program, and said second operation area is used for storing said transmission data.

7. The information security transmission system of claim 1, wherein said first information equipment further comprises at least one first storage media, and said second information equipment further comprises at least one second storage media, wherein said first storage media is used for storing a transmission data, which comprises an original data and a control program, wherein said transmission data will be transmitted since said original data and said control program have been edited, and said second storage media is used for storing said transmission data received from said second information equipment, and processing said control program to remove said transmission data stored within said second information equipment.

8. The information security transmission system of claim 1, further comprising an information manager end connected to said network, said information manager end comprising at least one conditional content, wherein while said first information equipment transmits a transmission data to said information manager end through said network, said information data will be confirmed to said conditional content to result that said information manager end will process according to said conditional content.

9. An information security transmission system, comprising:
a first information equipment, comprising a first dynamic codec to process the tolerance coding for a data, which will be transmitted from said first information equipment; and
a second information equipment connected to said first information equipment through a network, wherein said second information equipment comprises a second dynamic codec to decode the data, which will be received from said second information equipment;
wherein said first dynamic codec comprises a positioned value and a code book, said positioned value points to said code cook, wherein said first dynamic codec will divide a data into a plurality of sub-data segments, said data will be transmitted to said second information equipment, said sub-data segments can be with dynamic data length, wherein said sub-data segments are related with each other depending on said code book, and each sub-data segment is coded by said first dynamic codec in respect to the fault-tolerant coding to be formed as a coding data, which will be transmitted to said second information equipment for data correction.

10. The information security transmission system of claim 9, wherein said first information equipment and said second information equipment are respectively selected to be a client end information equipment or a server end information equipment.

11. The information security transmission system of claim 9, wherein first information equipment further comprises at least one first storage media, and said second information equipment further comprises at least one second storage media, wherein said first storage media is used for storing a manager program and said transmission data, which comprises an original data and a control content, wherein said transmission data will be transmitted since said original data and said control content have been edited, and said second storage media is used for storing said manager program and said transmission data received from said second information equipment, wherein said control content of said transmission data will trigger said manager program within said second storage media, and remove said transmission data stored within said second information equipment.

12. The information security transmission system of claim 11, wherein said first storage media comprises a first storage area and a first operation area, said first storage area is used for storing said manager program, and said first operation area is used for storing said transmission data, furthermore, said second storage media comprises a second storage area and a second operation area, said second storage area is used for storing said manager program, and said second operation area is used for storing said transmission data.

13. The information security transmission system of claim 9, wherein said first information equipment further comprises at least one first storage media, and said second information equipment further comprises at least one second storage media, wherein said first storage media is used for storing a transmission data, which comprises an original data and a control program, wherein said transmission data will be transmitted since said original data and said control program have been edited, and said second storage media is used for storing said transmission data received from said second information equipment, and processing said control program to remove said transmission data stored within said second information equipment.

14. The information security transmission system of claim 9, further comprising an information manager end connected to said network, said information manager end comprising at least one conditional content, wherein while said first information equipment transmits a transmission data to said information manager end through said network, said information data will be confirmed to said conditional content to result that said information manager end will process according to said conditional content.

15. An information security transmission system, comprising:
a first information equipment obtaining at least one certification data to process a information transmission;
a second information equipment connected to said first information equipment through a network for processing an information transmission with said second information equipment; and
a certificate authority connected to said first information equipment and said second information equipment through said network, comprising a certificate authority database, wherein said certificate authority will process certification login according to said certification data, and further said certification data will be stored within said certificate authority database, and a authorization will be obtained for further processing a certification process;
wherein said certificate authority will generate a first key pair and second key pair, and transmit said first key pair and second key pair to said first information equipment and second information equipment for processing the encryption/decryption, wherein said first information equipment and second information equipment respectively comprises a first dynamic codec and second dynamic codec, said first dynamic codec generates a positioned value and a code book, said positioned value points to said code book, said first dynamic codec will divide a data into a plurality of sub-data segments, said data will be transmitted to said second information equipment, said sub-data segments can be with dynamic data length, wherein said sub-data segments are related with each other depending on said code book, and each sub-data segment is coded by said first dynamic codec in respect to the fault-tolerant coding to be formed as a coding data, which will be transmitted to said second information equipment for data correction.

16. The information security transmission system of claim 15, wherein said first key pair comprises a first public key and a first private key, and said second key pair comprises a second public key and a second private key, wherein said second public key and said first private key are transmitted to said first information equipment, and said first public key and said second public key are transmitted to said second information equipment.

17. The information security transmission system of claim 15, wherein said first information equipment and said second information equipment can respectively issue a request actively to said certificate authority for switching said key pairs.

18. The information security transmission system of claim 15, wherein said first information equipment and said second information equipment are respectively selected to be a client end information equipment or a server end information equipment.

19. The information security transmission system of claim 15, wherein first information equipment further comprises at least one first storage media, and said second information equipment further comprises at least one second storage media, wherein said first storage media is used for storing a manager program and said transmission data, which comprises an original data and a control content, wherein said transmission data will be transmitted since said original data and said control content have been edited, and said second storage media is used for storing said manager program and said transmission data received from said second information equipment, wherein said control content of said transmission data will trigger said manager program within said second storage media, and remove said transmission data stored within said second information equipment.

20. The information security transmission system of claim 19, wherein said first storage media comprises a first storage area and a first operation area, said first storage area is used for storing said manager program, and said first operation area is used for storing said transmission data, furthermore, said second storage media comprises a second storage area and a second operation area, said second storage area is used for storing said manager program, and said second operation area is used for storing said transmission data.

21. The information security transmission system of claim 15, wherein said first information equipment further comprises at least one first storage media, and said second information equipment further comprises at least one second storage media, wherein said first storage media is used for storing a transmission data, which comprises an original data and a control program, wherein said transmission data will be transmitted since said original data and said control program have been edited, and said second storage media is used for storing said transmission data received from said second information equipment, and processing said control program to remove said transmission data stored within said second information equipment.

22. The information security transmission system of claim 15, further comprising an information manager end connected to said network, said information manager end comprising at least one conditional content, wherein while said first information equipment transmits a transmission data to said information manager end through said network, said information data will be confirmed to said conditional content to result that said information manager end will process according to said conditional content.

23. An information security transmission system, comprising:
a first information equipment comprising at least one first storage media, which is used for storing a manager program and a transmission data, wherein said transmission data comprises an original data and a control content, said transmission data will be transmitted since said original data and said control content have been edited; and
a second information equipment comprising at least one second storage media, which is used for storing said manager program and said transmission data received from said second information equipment, wherein said control content of said transmission data will trigger said manager program within said second storage media, and remove said transmission data stored within said second information equipment.

24. The information security transmission system of claim 23, wherein said first storage media comprises a first storage area and a first operation area, said first storage area is used for storing said manager program, and said first operation area is used for storing said transmission data, furthermore, said second storage media comprises a second storage area and a second operation area, said second storage area is used for storing said manager program, and said second operation area is used for storing said transmission data.

25. An information security transmission system, comprising:
a first information equipment comprising at least one first storage media, which is used for storing a transmission data, wherein said transmission data comprises an original data and a control program, said transmission data will be transmitted since said original data and said control program have been edited; and
a second information equipment comprising at least one second storage media, which is used for storing said transmission data received from said second information equipment, and processing said control program to remove said transmission data stored within said second information equipment.
